(19) United States
(12) Patent Application Publication
(10) Pub. No.: US 2020/0019595 A1
(43) Pub. Date: Jan. 16, 2020

(54) SYSTEM AND METHOD FOR GRAPHICAL VECTOR REPRESENTATION OF A RESUME

(71) Applicant: Giovanni Azua Garcia, Zurich (CH)

(72) Inventor: Giovanni Azua Garcia, Zurich (CH)

(21) Appl. No.: 16/460,166

(22) Filed: Jul. 2, 2019

Related U.S. Application Data
(60) Provisional application No. 62/697,194, filed on Jul. 12, 2018.

(51) Int. Cl. G06F 17/24; G06Q 10/10; G06F 17/18; G06T 11/20

(52) U.S. Cl. CPC G06F 17/24; G06Q 10/1053; G06T 2200/24; G06T 11/206; G06F 17/18

(57) ABSTRACT

The present invention relates to a system, data science method and visualization for generating a graphical representation of a resume. The system may generate different graphical elements to form a holistic graphical representation of a resume in vector graphic form, and may, by using a class of machine learning algorithms, cluster related skills into skill groups and visualize the resulting skill groups as a word cloud. The system also uses a stacked bar chart to visualize education, professional experiences, and accomplishments. The system may also use a context word cloud to visualize the context and responsibilities covered by education and professional experiences. A pie and donuts chart may be used to visualize the job titles and industry sectors. Finally, skill group badges may be generated to quickly identify the top skills of a candidate thus enabling resume readers to identify a candidate match instantly.

### CROSS-REFERENCE TO RELATED PATENT DOCUMENTS

This patent application claims the benefit of priority of U.S. Provisional Application No. 62/697,194 entitled “SYSTEM AND METHOD FOR GRAPHICAL VECTOR REPRESENTATION OF A RESUME,” filed Jul. 12, 2018, which are hereby incorporated herein by reference in its entirety.

### TECHNICAL FIELD OF THE INVENTION

The present invention relates in general to information processing and data visualization, and, more particularly, to a system and method that uses data science for generating a graphical representation of a resume optimized for rapid information conveyance. It is inspired in the concept that a picture is worth a thousand words and the notion that a single image conveys its meaning or essence more effectively than a textual description. Therefore, the present invention described through this disclosure is also associated with the trademark “1KWCV” as abbreviation for “one thousand words CV” or resume.

### COPYRIGHT AND TRADEMARK NOTICE

A portion of the present disclosure may include material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of the present invention to material associated only with such marks.

### BACKGROUND OF THE INVENTION

Resumes have traditionally been written as a text-based representation of a job candidate's educational and professional background, and may include demographic information, educational information, professional experiences, responsibilities, accomplishments, and skills. Generally, resumes are written by job candidates and read by intermediary recruitment agents or prospective employers. Despite different attempts to create visual representations of a resume, the current representations are linearly textual and may span multiple pages. The linearly textual representation of a resume presents the candidate's information inefficiently, and thus, makes it difficult for the recruiters or prospective employers to shortlist candidates or to make a definitive hiring decision. These recruiters and employers need to either compromise their reviews and skim through or linearly read the entire resume documents. It is said that the recruiters or prospective employers spend a maximum of six seconds to skim through a resume in order to decide whether the job candidate should be shortlisted or not for any other rounds of interviews. Being required to skim through and read hundreds of resumes may prove to be tiresome and quickly lead to discarding what would otherwise be good candidate matches for a job.

The textual representation of a resume also provides limited information and context for the recruiting agents or prospective employers to make a decision of whether the candidate is a good match or not. As a result, multiple rounds of interviews are required to fill the information gaps caused by the poor textual representation of a resume. For example, a typical resume lists a candidate's professional experiences but fail to provide specific information on how much a certain skill or skills were used or explored during the term of those professional experiences. When the skills are listed in a resume, they usually appear in isolation from the professional experiences, and, even if they are listed together in the resume, it is not possible to tell how frequently or how recently those skills had been used or explored. The same issues occur with a candidate's educational information, where in a current textual resume, it is not possible to know what skills were learned during the period of a listed education or whether they were learned and applied during the professional experiences of the candidate.

In general, it is also not possible to know what are the top skills of the candidates. The information gap caused by the textual resumes leads to many issues. For example, in a job interview questions, a prospective employer may be forced to ask the candidate about skills that are listed in her resume but those skills may not had been used frequently or recently enough for the candidate to succeed. Likewise, a candidate starting a new job based on a decision taken from her resume may lead to a job placement mismatch because various skills listed in her resume were also not mastered well enough nor used recently enough. Another issue with the textual resumes is that the various skills are listed one by one, while, in reality, most of the skills form natural skill groups with other skills that are often and naturally used together. Because job candidates generally tend to include only fewer isolated skills out of a skill group, they may miss opportunities to be shortlisted by skills that are naturally related or part of the skills group to which their skills belong to. In recent years, new computer methods have emerged to extract structure from a textual resume, but many of the aforementioned shortcomings still exist. The textual resumes in their current form appear in many different file formats and styles making it hard for the recruiting agents or prospective employers to have a standardized and convenient digital application for quickly and efficiently navigating through many resumes. For that matter, it is also difficult to compare two resumes when the information is linearly textual and lacks the quantitative information that would allow to answer specific questions such as whether one candidate has more experience in a particular skill than another, which candidate has used that skill more frequently or recently, which candidate ranks highest in a particular skill, or which candidate has actually applied certain skills in a given industry or sector.

The use of computers to generate graphical displays that illustrate the relationships of underlying data is well known. A computer may be used, for example, to generate a bar graph that illustrates the relationship between a set of data values taken at different points in time. Stacked bar charts, also known as stacked bar graphs, are graphs used to break down and compare parts of a whole. Each bar in the chart represents a whole, and various segments in the bar represent different parts or categories of that whole. Similarly, a pie and donuts chart shows the relationship of parts to a whole.

A word cloud is a visual representation of text data, typically used to visualize free form texts. They are usually shown as single words, and the importance of each word is shown with font size or color. This format is useful for quickly conveying the most prominent terms according to some quantitative measure, such as the frequency of occurrence of terms in a book.

Clustering is a task of grouping a set of objects in such a way that objects in the same group are more similar to each other than to those in other groups. It is a main task of exploratory data mining, and a common technique for statistical data analysis used in many fields, including machine learning.

Vector graphics use 2D point-located polygons to represent images in computer graphics. Each of these points has a definite position on the x- and y-axes of the work plane and determines the direction of the path. Furthermore, each path may be assigned with various attributes, including such values as stroke, color, shape, curve, thickness, and fill. Vector graphics are commonly found today in the SVG, EPS, and PDF graphic file formats and are completely different than the more common raster graphics file formats of JPEG, PNG, and MPEG4. Vector data can be easily scaled and otherwise manipulated to accommodate the resolution of a spectrum of output devices.

The forgetting curve hypothesizes the decline of memory retention in time. This curve shows how information is lost over time when there is no attempt to retain it. A related concept is the strength of memory that refers to the durability that memory traces in the brain. The stronger the memory, the longer period of time that a person is able to recall it. A typical graph of the forgetting curve purports to show that humans tend to halve their memory of newly learned knowledge in a matter of days or weeks unless they consciously review the learned material. The forgetting curve supports one of the seven kinds of memory failures: transience, which is the process of forgetting that, occurs with the passage of time. In 1885, Hermann Ebbinghaus collected data to plot a forgetting curve. Today, we approximate forgetting with an exponential curve. [https://en.wikipedia.org/wiki/Forgetting curve]

In light of the above, there is a need in the art for a system and method for using data science and visualization methods for generating a graphical representation of a resume optimized for rapid information conveyance that will address such issues. It is to these ends that the present invention has been developed.

### BRIEF SUMMARY OF THE INVENTION

To minimize the limitations in the prior art, and to minimize other limitations that will be apparent upon reading and understanding the present specification, the present invention describes a system and method using data science and visualization for generating a graphical representation of a resume optimized for rapid information conveyance.

It is an objective of the present invention to provide a data science method and visualization that may generate and link different graphical elements to form a holistic graphical representation of a resume in a vector graphic form. The method employs quantitative data, more specifically, the percent (or similar measure e.g., probability) of use of skills over the years.

It is another objective of the present invention to define the use of a class of machine learning algorithms that may cluster related skills into one or more skill groups and visualize the resulting skill groups as a word cloud.

It is another objective of the present invention to provide a data science method that may employ a weighting scheme for generating a skill word cloud that makes skill font sizes bigger by a two-fold criterion, namely higher frequency and most recent usage. The weighting scheme is based on the exponential decline of memory retention over time of those skills i.e., the forgetting curve.

It is another objective of the present invention to provide a data science method that may use a bar chart and extensions of it to visualize educational information, job experiences, and accomplishments along with the percent of use of the one or more skill groups over the years.

It is another objective of the present invention to provide a data science method that may generate bar graphs to illustrate the relationship between the percent of use of the one or more skill groups over the years.

It is another objective of the present invention to provide a data science method that may use a context word cloud to visualize the context i.e., what was done during those professional or educational experiences and what responsibilities were covered during those time periods.

It is another objective of the present invention to provide a data science method that may use a pie and donuts chart to visualize the job titles and industry sectors that correspond to the professional experiences.

It is another objective of the present invention to provide a data science method that may define skill group badges conventions that combine frequency and most recent use of the one or more skill groups for identifying the top skills of a candidate and enable resume readers to identify a candidate match instantly.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a data science system for generating a holistic graphical representation of a resume in a vector graphic form, according to an exemplary embodiment of the present invention;

FIG. 2 illustrates a flowchart of a conceptual data science method and algorithm to generate the holistic graphical representation of the resume in the vector graphic form using various data sources, according to an exemplary embodiment of the present invention;

FIG. 3 illustrates a legend with various black and white patterns that distinguish components in various illustrations and what colors they correspond to, according to an exemplary embodiment of the present invention;

FIG. 4 illustrates a word cloud of a set of skill groups where each skill group contains closely related skills that are generally used together or were used together during experiences of a specific candidate, according to an exemplary embodiment of the present invention;

FIG. 5 illustrates a stacked bar chart where each bar corresponds to a year of educational and/or professional experience and the bar segments correspond to the percent of use of each skill in the set of skill groups within the course of that year, according to an exemplary embodiment of the present invention;

FIG. 6 illustrates a word cloud of the context on which all the skill groups are applied, in which each context links to the educational or professional experience where it was last used, and also include the responsibilities that the candidate had during those experiences, according to an exemplary embodiment of the present invention;

FIG. 7 illustrates a pie and donuts chart that shows a relationship of titles of the educational or professional experiences as components of the whole, according to an exemplary embodiment of the present invention;

FIG. 8 illustrates a set of badges that reveal a level of expertise using those skill groups, according to an exemplary embodiment of the present invention;

FIG. 9 illustrates an exemplary resume as compiled by the data science system data science, according to an exemplary embodiment of the present invention; and

FIG. 10 is a block diagram that illustrates a system architecture of a computer system for generating the holistic graphical representation of the resume in the vector graphic form, according to an exemplary embodiment of the present invention.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to information processing and data visualization, and, more particularly, to using data science methods for generating a holistic graphical representation of a resume optimized for rapid information conveyance. The system the present invention uses the data science method for generating the holistic graphical representation of the resume optimized.

As contemplated by the present invention, a primary object of the system is to facilitate and execute a computer method to generate the holistic graphical representation of the resume in a vector graphic form. The data science method may take as input multiple data sources such as but not limited to: a database of precomputed skill group clusters; candidate's demographic data, percent of use of skills per year, responsibilities, accomplishments, educational, and professional experiences. Furthermore, the data science method may generate, store, and transfer an intermediary snapshot of the candidate's data using well-known portable formats such as XML or JSON.

A web browser and application may be used to allow the candidate to enter the required quantitative data including the percent of use of various skills per year. Other methods may be devised for automatically parsing such data from a textual resume into a structured form. However, textual resumes lack the quantitative information needed to generate the stacked bar chart with the percent of use of the various skills per year and this may only be predicted as starting point for the candidate to review and correct. Machine learning methods may be employed to generate first suggestions as starting point for a candidate to enter into the system her correct percent of use of the various skills per year. For example, a method may use aggregated data of other candidates that have similar career histories and compute, for example, a prior probability that in a given year a candidate that works in company X has used skills Y and use this probability as suggested initial percent of use of the skills Y for the candidate.

Before describing the present invention in detail, it should be observed that the present invention utilizes a combination of components, which constitutes a system for facilitating and executing the data science method for generating the holistic graphical representation of the resume optimized. Accordingly, the components have been represented, showing only specific details that are pertinent for an understanding of the present invention so as not to obscure the disclosure with details that may be readily apparent to those with ordinary skill in the art having the benefit of the description herein. As required, the detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems and methods have been described above, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

The method and system of the present invention will now be described with reference to the accompanying drawings, which should be regarded as merely illustrative without restricting the scope and ambit of the present invention.

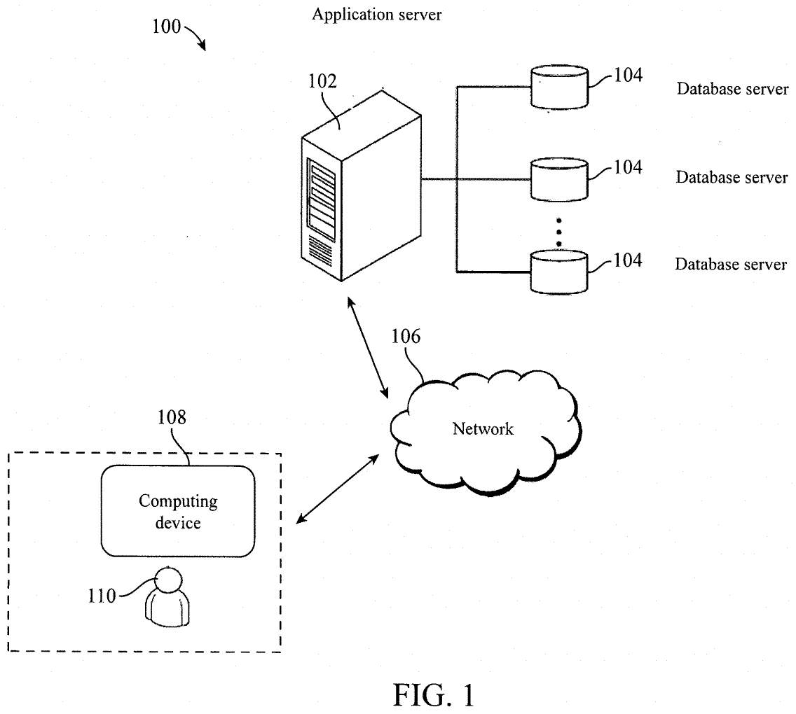

FIG. 1 illustrates a data science system 100 for generating a holistic graphical representation of a resume in a vector graphic form, according to an exemplary embodiment of the present invention. The system environment 100 includes an application server 102, one or more database servers such as a database server 104, and a network 106. The system environment 100 further includes one or more candidate computing devices associated with one or more candidates such as a candidate computing device 108 associated with a candidate 110. The application server 102 and the candidate computing device 108 may communicate with each other over a communication network such as the network 106. The application server 102 and the database server 104 may also communicate with each other over the same network 106 or a different network.

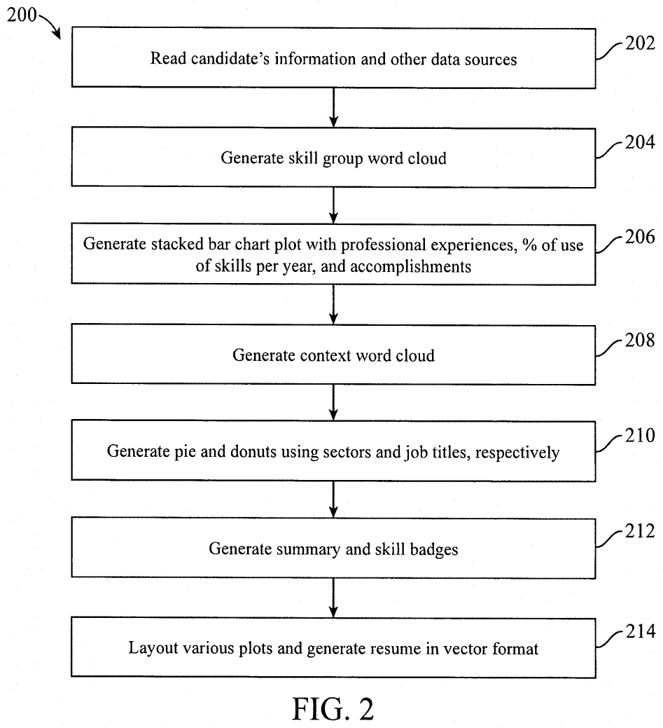

The application server 102 is a computing device, a software framework, or a combination thereof, that may provide a generalized approach to create the application server implementation. Various operations of the application server 102 may be dedicated to execution of procedures, such as, but are not limited to, programs, routines, or scripts stored in one or more memory units for supporting its applied applications and performing defined operations. For example, the application server 102 may be configured to facilitate and execute a data science method and visualization that generates and links different graphical elements to form one or more holistic graphical representation of one or more resumes (of one or more candidates such as the candidate 110) in a vector graphic form. The method employs quantitative data, more specifically, the percent (or similar measure e.g., probability) of use of one or more skills over the years. The application server 102 may be further configured to define the use of a class of machine learning algorithms that may cluster related skills into one or more skill groups and visualize the resulting skill groups as a word cloud. The application server 102 may be further configured to employ a weighting scheme for generating a skill word cloud that makes skill font sizes bigger by a two-fold criterion, namely higher frequency and most recent usage. The weighting scheme is based on the exponential decline of memory retention over time of those skills i.e., the forgetting curve. The application server 102 may be further configured to use a bar chart and extensions of it to visualize educational information, job experiences, and accomplishments along with the percent of use of the one or more skill groups over the years. The application server 102 may be further configured to generate one or more bar graphs to illustrate the relationship between the percent of use of the one or more skill groups over the years. The application server 102 may be further configured to use a context word cloud to visualize the context i.e., what was done during those professional or educational experiences and what responsibilities were covered during those time periods. The application server 102 may be further configured to use one or more pie and donuts charts to visualize the job titles and industry sectors that correspond to the professional experiences. The application server 102 may be further configured to define one or more skill group badges conventions that combine frequency and most recent use of the one or more skill groups for identifying the top skills of the one or more candidates (such as the candidate 110) and enable resume readers to identify a candidate match instantly. Various other operations of the application server 102 have been described in detail in conjunction with FIGS. 2-9.

The application server 102 may be realized through various web-based technologies, such as, but not limited to, a Java web-framework, a .NET framework, a professional hypertext preprocessor (PHP) framework, a python framework, or any other web-application framework. The application server 102 may also be realized as a machine-learning and artificial intelligence (AI) based model that implements any suitable machine-learning techniques, AI techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the application server 102 may include, but are not limited to, a personal computer, a laptop, or a network of computer systems. The application server 102 may operate on one or more operating systems such as Windows, Android, Unix, Ubuntu, Mac OS, or the like.

The database server 104 may include suitable logic, circuitry, interfaces, and/or code, executable by the circuitry that may be configured to perform one or more data management and storage operations such as receiving, storing, processing, and transmitting queries, data, content, resumes, or the like. In an embodiment, the database server 104 may be a data management and storage computing device that is communicatively coupled to the application server 102 or the candidate computing device 108 via the network 106 to perform the one or more operations.

In an exemplary embodiment, the database server 104 may be configured to manage and store one or more candidate resumes of the one or more candidates such as the candidate 110. The database server 104 may be configured to manage and store a plurality of candidate data of the one or more candidates (such as the candidate 110). The plurality of candidate date may include a percentage (or similar measures such as probability) of use of one or more skills per year data, education history, work history, work responsibilities, and demographic information. More specifically, the database server 104 may be configured to manage and store a set of precomputed skill group clusters, candidate's demographic data of the one or more candidates, the percentage of use of the one or more skills per year, and responsibilities, accomplishments, educational and professional experiences of the one or more candidates. The database server 104 may be configured to manage and store one or more skill word clouds, one or more bar graphs, one or more context word clouds, one or more pie and donuts charts, and one or more skill group badges conventions. In an exemplary embodiment, the database server 104 may be further configured to manage and store one or more holistic graphical representation of the one or more resumes in a vector graphic form generated by the application server 102.

In an embodiment, the database server 104 may be configured to receive a query from the application server 102 for retrieval of the stored information. Based on the received query, the database server 104 may be configured to communicate the requested information to the application server 102. Examples of the database server 104 may include, but are not limited to, a personal computer, a laptop, or a network of computer systems.

The network 106 may include suitable logic, circuitry, interfaces, and/or code, executable by the circuitry that may be configured to transmit messages and requests between various entities, such as the application server 102, the database server 104, and the candidate computing device 108. Examples of the network 106 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the application server 102 may be configured to retrieve the plurality of candidate data of the candidate 110 from the candidate computing device 108 or the database server 104 over the network 106. The plurality of candidate data may include at least percentage (or similar measures such as probability) of use of the one or more skills per year data, education history, work history, work responsibilities, and demographic information. In an embodiment, the application server 102 may render a user interface on the candidate computing device 108 for retrieving the plurality of candidate data. The user interface includes a web application and prompts the candidate 110 to enter the plurality of candidate data. The application server 102 may further include a social network crawler or integration with its public API. The social network crawler (or via its public API access) acquires the plurality of candidate data from one or more social network profiles of the candidate 110. The plurality of candidate data acquired from the one or more social network profiles of the candidate 110 may be compared against a reference database to generate a recommended candidate data set. The recommended candidate data set may be further presented to the candidate 110 on the candidate computing device 108 for review and modification prior to processing by the application server 102 using a set of algorithms or instructions. The set of algorithms or instructions may include at least a word cloud algorithm or instructions, a stacked bar chart algorithm or instructions, a pie and donuts algorithm or instructions, and a badge algorithm or instructions.

Further, the application server 102 may be configured to generate at least one or more skill word clouds, one or more stacked bar charts, one or more context word clouds, one or more pie and donuts charts, and a set of badges based on the respective candidate data. For example, the application server 102 executes the word cloud algorithm or instructions to process the plurality of candidate data to generate a word weight and a word color associated with the plurality of candidate data. The execution of the word cloud algorithm or instructions outputs the plurality of candidate data modified by the word weight and the word color as a word cloud comprising at least one of the skill word cloud or the context word cloud. The application server 102 further executes the stacked bar chart algorithm or instructions to process the plurality of candidate data including a percentage of use of the one or more skills per year to generate a plurality of stacked bars associated with the plurality of candidate data. The execution of the stacked bar chart algorithm or instructions outputs the plurality of percentage of use of the one or more skills per year as the stacked bar chart. The application server 102 further executes the pie and donuts algorithm or instructions to process the plurality of candidate data to generate a plurality of pie and donuts associated with the plurality of candidate data. The execution of the pie and donuts algorithm or instructions outputs the plurality of candidate data as the pie and donuts chart. The application server 102 further executes the badge algorithm or instructions to process the plurality of candidate data to generate a plurality of badges associated with the plurality of candidate data. The execution of the badge algorithm or instructions outputs the plurality of candidate data as a plurality of badges of the set of badges. The application server 102 is further configured to generate the graphical vector resume for the candidate 110 based on the word cloud, the stacked bar chart, the pie and donuts chart, the plurality of badges and a summary. The generated skill word cloud, the generated stacked bar chart, the generated context word cloud, the generated pie and donuts chart, and the generated set of badges are compiled together to generate the graphical vector resume for the candidate 110. The graphical vector resume is printable on a single sheet of paper or displayable on different output devices. Various operations of the application server 102 have been described in detail in conjunction with FIGS. 2-9.

FIG. 2 illustrates a flowchart 200 of a conceptual data science method and algorithm to generate the holistic graphical representation of the resume in the vector graphic format using as input various data sources, according to an exemplary embodiment of the present invention. At step 202, candidate's information of a candidate (such as the candidate 110) and other data sources are read by the application server 102. The step 202 in the method workflow may correspond to loading various data sources for assisting the algorithm, for example, a database (such as the database server 104) of precomputed skill group clusters and centroids (more on this later). The application server 102 may load the candidate's data from a data source such as the database server 104 or from a portable format such as JSON. The candidate's data may include information such as, but are not limited to, candidate's demographic information, percentage of use of one or more skills per year, responsibilities, accomplishments, educational, and professional experiences. The experiences may include the context information i.e., what was done and what responsibilities were covered by those educational and professional experiences.

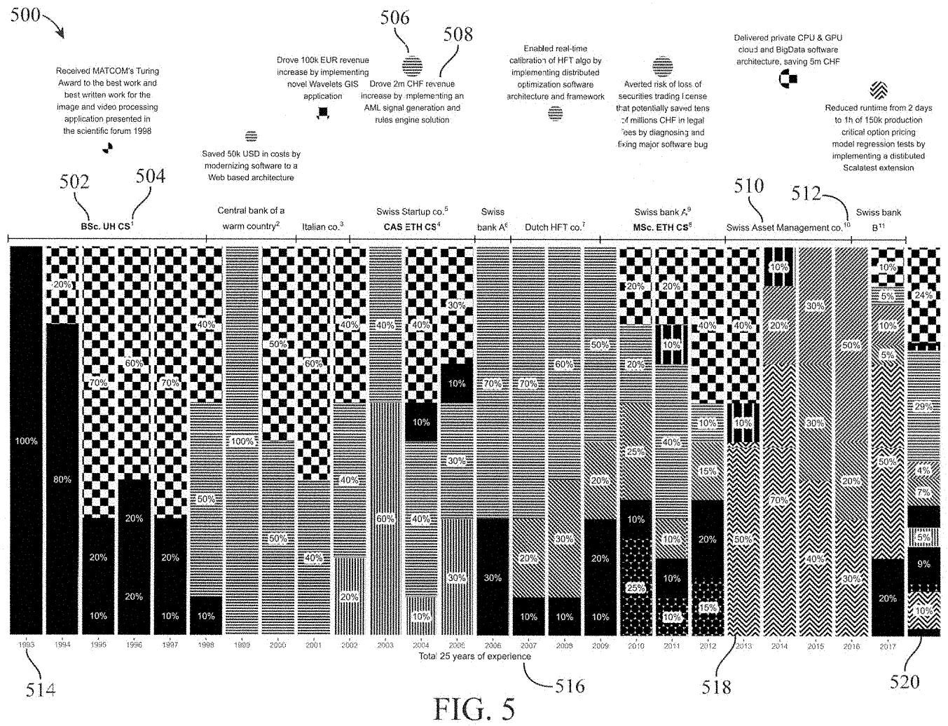

At step 204, the method workflow (executed by the application server 102) takes as input the percentage of use of the one or more skills per year, computes the unique skill groups, and assigns a weight to each skill group using the weighting scheme (discussed later). The skill groups may then be sorted by weight in descending order and assigned a predefined colors palette. This method ensures that for any resume certain colors may be associated with the top skills mastered by the candidate. For example, for a given palette, the color red may be always assigned to the top weighted skill of any candidate. This is another visual help for the resume reader to quickly identify the candidate's top skills. The color assignment may be reused for the subsequent method steps and visual elements. Finally, a generic word cloud algorithm is executed by the application server 102 to generate a skill group word cloud as depicted in FIG. 4. It uses the skill names and associated weights as input.

At step 206, the method workflow (executed by the application server 102) takes as input the professional experiences and education name and place, and, generates line demarcations revealing the duration of those experiences within the stacked bar chart plot. Each professional and educational experience is assigned with a number that uniquely identifies it across all other resume visual elements. The stacked bar chart is then generated by the application server 102 using the percentage of use of the one or more skills per year. The accomplishments assigned to each experience may also be read and plotted on top of the corresponding job experiences. The overall sum of percentage of use of the one or more skills is computed for all the years and added as extra bar in the stacked bar chart plot. An exemplary stacked bar chart plot generated in this fashion is depicted in FIG. 5.

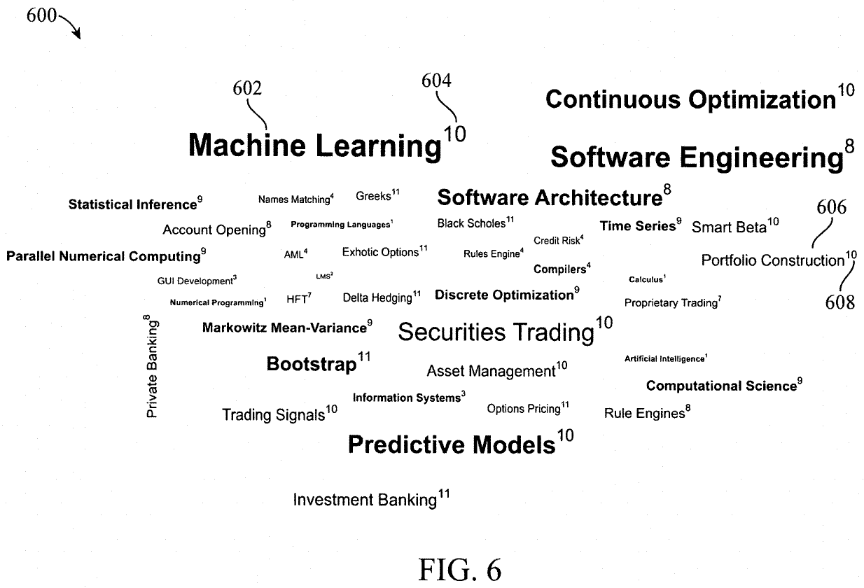

At step 208, the method workflow (executed by the application server 102) takes as input all professional and educational experiences and the associated context information. It then groups all distinct context information by name and assigns to it the unique identifier of the professional or educational experience where it was last used, and using the same weighting scheme as for the skills (discussed later), assigns a weight to each context. Finally, a generic word cloud algorithm is executed by the application server 102 to generate a context word cloud as depicted in FIG. 6. It uses the context names and associated weights as input.

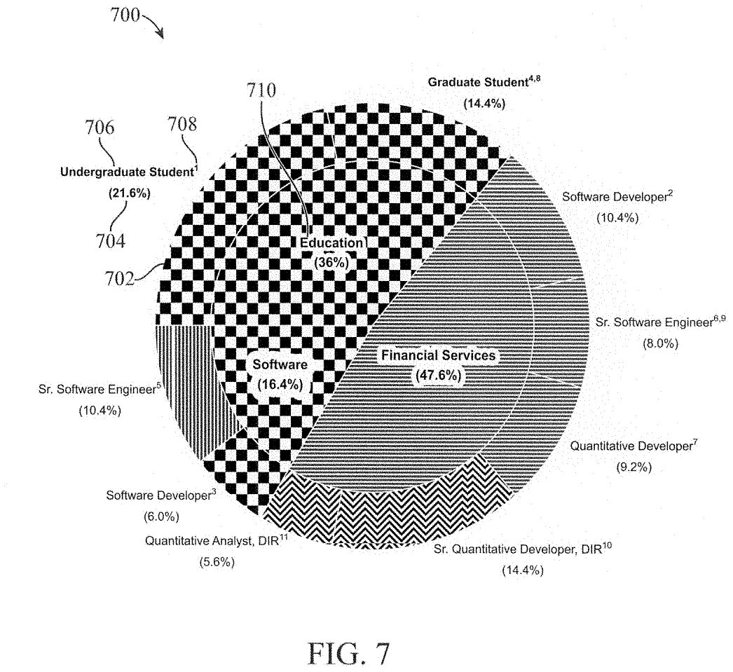

At step 210, the method workflow (executed by the application server 102) takes as input the titles of all professional and educational experiences. It also takes as input the percentage of use of the one or more skills per year segregated per professional or educational experience. The pie chart shows the relationship of different industry sectors to the whole career, for example, FIG. 7 shows that the experiences corresponding to the education sector take 36 percent of the whole career. Since each professional or educational experience contains the sector or industry information it applies to, each sector pie size is calculated grouping all experiences by the sector. Similarly, the donuts chart shows the relationship of titles to the whole sector they apply to. In this case, the experiences are grouped by title. For example, multiple experiences that belong to the same sector and where the candidate had the same title may be grouped together and their percentage may be their total sum divided by the total sum of all experiences. The calculations are done using the percentage of use of the one or more skills per year, in this case segregated by experience. It is important to use as input the percentage because they reflect the actual amount of work percent-wise corresponding to each experience as opposed to using time such as in number of months or years. The reason for doing so is that using time would be ambiguous and the time would count multiple times in case that a candidate has two simultaneous experiences, for example, multiple simultaneous professional experiences or a simultaneous professional and educational experience. A pie and donuts chart is then generated such as the exemplary one depicted in FIG. 7.

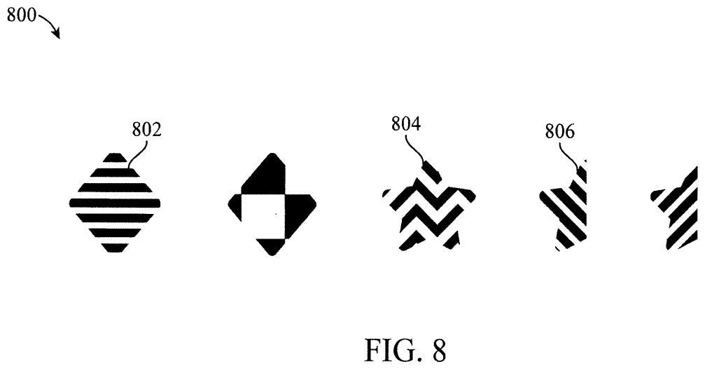

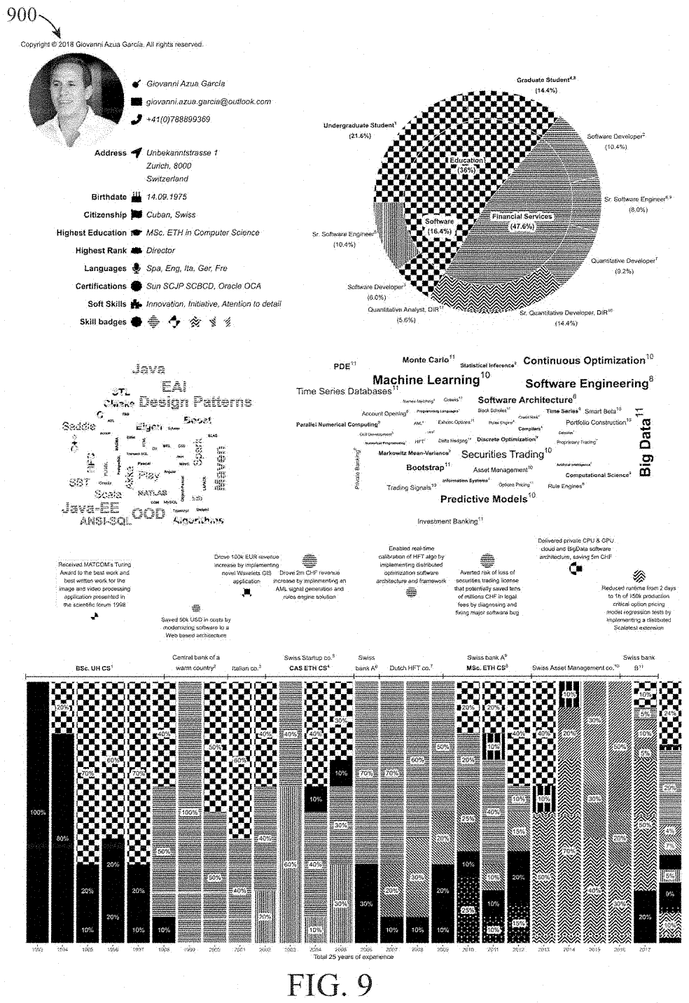

At step 212, the method workflow (executed by the application server 102) takes as input the candidate's demographic information to generate the summary section of the vector resume. This step also takes the percentage of use of the one or more skills per year. The badges are calculated in two steps: first summing all percentage of use of the one or more skills per skill group and second by testing whether the skill group had been used within the last three, two or one year. An exemplary badges output is depicted in FIG. 8.

At step 214, the method workflow (executed by the application server 102) layouts the different plots into a single file such as an A4 compatible output in a vector format.

Another objective of the present invention is to use a class of machine learning algorithms to cluster skills and visualize the resulting skill groups as a word cloud. The clustering may be done by the application server 102 using machine learning algorithms such as the k-means. The skill groups are associated with colors that are used to uniquely identify the skill group and cross link it to other graphical elements and plots. The skill group word cloud also serves as a legend.

There are multiple ways to construct a reference database of clustered skill groups using machine learning and more specifically by using the k-means algorithm or similar alternatives such as MMSK-means. First, it is necessary to collect the raw skills data. The simplest way to do so is to build a web application with input elements that enables the one or more candidates (such as the candidate 110) to enter their skills from a browser and web application (running on the candidate computing device 108) into a database system (such as the database server 104). The application server 102 may render a user interface on the candidate computing device 108 in which the user interface includes the browser and web application for inputting the requisite candidate data. In this case, the skills of each candidate would correspond to a single sample data point. Another way is to reuse readily available skill and skill affinity databases from the internet. Every affinity skill group would serve as a single sample data point. Yet another way is to import candidate's data from professional social networks, each candidate's skills would correspond to a single sample data point. Finally, it would be plausible to use a web application, let the candidate upload her textual resume and parse the candidate's resume to collect the skills and every uploaded textual resume would correspond to a single sample data point. The application server 102 may include a social network crawler or integration with its public API to acquire or retrieve the plurality of candidate data from the candidate's social network profile. The aforementioned are four different ways to collect input data for constructing the reference cluster skill groups.

In order to convert the skill keywords into a valid data input for the clustering algorithms, the skill keywords are preprocessed i.e., de-duplicated, typos removed, and the like. Then, a union of all the skills segregated per ontology e.g., different industry or sector are sorted and saved into a vector that assigns a unique index number e.g., an index from 1 to 10 million to each unique skill. Consequently, all the candidate's skills sample points collected are quantitatively mapped to a numbers vector. This input format allows to cast this as a clustering algorithm. We have the n d-dimensional sample points mapped to number vectors:

X={x₁, . . . , xₙ} where x∈ [symbol] ^{d}:

The k-means or similar clustering algorithm outputs the assignment function c(x) i.e., a function that assigns each sample point to the corresponding cluster {1, . . . , k}:

c(x): [symbol] →{1, . . . , k}

The centroids or prototypes i.e., center of the clusters is computed by calculating the mean of the samples assigned to a cluster as follows:

$${Y}_{α} = \frac{1}{{n}_{α}} {\sum }_{x : c ( x ) = α} x with {n}_{α} = \# \{ x \text{:} c ( x ) = α \}$$

Now, we can store the cluster assignments c(x) and centroids Y₁, . . . , Yₖ into a database (such as the database server 104) and use this information to initialize and suggest possible skill clusters to the candidate (such as the candidate 110) while she enters her data via a web browser and application. The skill groups may be suggested to the candidate, for example, by first finding the closest cluster centroid Yᵢ to the skill that she provides as input. Then suggest as skill group the union of skills that are closest to that cluster centroid Yᵢ by some threshold i.e., the higher the threshold the bigger the suggested group. Therefore, when the candidate enters or provides a skill, a set of skills are suggested based on the proximity of the candidate's skill to the precomputed skill group clusters. Finally, all the skills entered by the candidate or parsed from her textual resume are grouped by the computed cluster assignments and given a unique color for visualizing it in the vector resume.

Another objective of the present invention is a weighting scheme for a word cloud that makes skill groups information more prominent by a two-fold criterion: the frequency of use of those skills and their most recent use. Skills whose frequency of use is higher may result in bigger font size. Likewise, skills that are more recently used may also contribute to bigger font size. The biggest font sizes correspond to skills that are both more frequently and recently used. The decline of memory retention in time has been related in the past to an exponential decline class of functions i.e., the forgetting curve. Therefore, the weighting scheme is defined as follows. Each candidate's year of experience e.g., 2003, 2004, etc. is assigned a weight using the Exponential Moving Average (EMA). The EMA assignment to the career years is done in such a way that, the closer the year to current's, the higher the weight, and thus, the prominence of the skill in the word cloud. Conversely, the further away the year is from current's, its weight may decrease exponentially, i.e., an exponential decay. This weighting model corresponds to an exponential decline of memory retention of those skills over the years.

Since we also have the percentage of use of each skill group per year, the prominence of the skills that belong to a skill group are proportional to the following quantity i.e., the sum of the percentage of use of the one or more skills times the exponential moving average weight assigned to that year:

$$Weight ( Skill i ) = {\sum }_{y = First career year}^{Last career year} \{ \% of use of skill i at year y \} \times E M A ( Year y )$$

The skills may be weighted together as part of their skill group and may also be weighted individually.

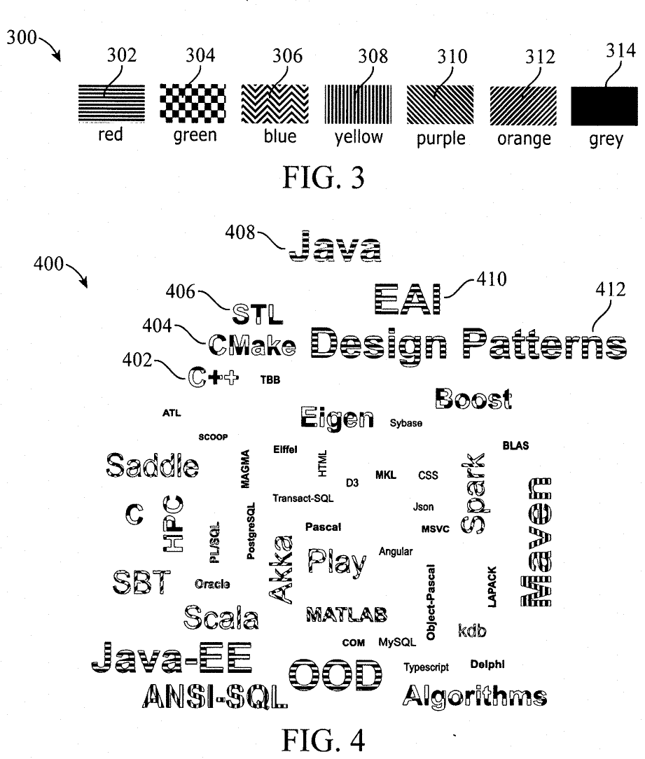

FIG. 3 illustrates a legend 300 with various black and white patterns that distinguish components in various illustrations and what colors they correspond to, according to an exemplary embodiment of the present invention. The legend 300 includes a first pattern 302 for illustrating a red color. The legend 300 includes a second pattern 304 for illustrating a green color. The legend 300 includes a third pattern 306 for illustrating a blue color. The legend 300 includes a fourth pattern 308 for illustrating a yellow color. The legend 300 includes a fifth pattern 310 for illustrating a purple color. The legend 300 includes a sixth pattern 312 for illustrating an orange color. The legend 300 includes a seventh pattern 314 for illustrating a grey color. Here, the various patterns of the legend 300 have been used for illustration purpose only. Any other patterns for illustrating any other colors may be used without limiting the scope of the present invention. Further, the various patterns or colors shown in the legend 300 may be interchangeably used without limiting the scope of the present invention.

FIG. 4 illustrates a word cloud 400 of a set of skill groups where each skill group contains closely related skills that are generally used together or were used together during the experiences of a specific candidate such as the candidate 110, according to an exemplary embodiment of the present invention. The skills 402, 404, and 406 belong to one skills group identified with the color green because they are very frequently used together. The skills 408, 410, and 412 are part of another skills group identified with the color red. The font size of skills 408, 410, and 412 is the biggest because those skills have been used more frequently and more recently than any other skills group. Furthermore, their font type is bold to indicate that those skills have been learned as part of some previous education whereas the regular font type indicates that the skills have been learned or applied as part of a professional experience.

Another objective of the present invention is to represent the percent of use of skill groups over the years as a stacked bar chart and provide extensions of it to better represent and relate the educational and professional history to the skills. Specific objects that may be implemented in such a stacked bar chart may include demarcations and job place labels corresponding to the years of that educational or professional experience. Each job place label may include a superscript number to uniquely identify it and cross link it to other plots. An extra bar may be included at the end that provides an overall sum of the percentage of use of the skill groups. Such a chart may also incorporate an x-axis label stating the total number of years of career experience including education, a plot extension at the top that reveals the main accomplishment of each education or professional experience, and the use of a word cloud in lieu of a legend to identify the skills groups by their color.

FIG. 5 illustrates a stacked bar chart 500 where each bar corresponds to a year of educational and/or professional experience, according to an exemplary embodiment of the present invention. The bar segments correspond to the percentage of use of each skill in the set of skill groups within the course of that year. The segments in the bars correspond to the frequency of use percent-wise of the skill group matching that color. The last bar reveals the total use of each skill group providing a total summary of their use. The stacked bar chart 500 is decorated on the top with demarcated periods in years that show the places of study or work. For each educational period or professional experience, there is a major accomplishment shown on top of it together with the main skill group used to do it. In FIG. 5, a label 502 shows an education that spans five and a half years. It may be identified as an education because its font style is bold. In FIG. 5, a label 504 shows the superscript “1” that uniquely identifies this education across all other graphical elements. In FIG. 5, labels 506 and 508 show the main accomplishment corresponding to professional experience “Swiss Startup Co.” between years 2002 and 2005. The impact of this accomplishment is visually revealed by the diameter of the dot and its height compared to the other accomplishments. We can see that this accomplishment was achieved using the skill group identified with color red. The impact has a value between 1 and 10, which is assessed and entered as input to the system by the candidate.

In FIG. 5, labels 510 and 512 show a professional experience of three and a half years. During that period, we can see that five different skill groups were used. In FIG. 5, a label 514 shows the x-axis ticks of the plot containing the year of the education or professional experience. In FIG. 5, a label 516 shows the total number of career years including education. In FIG. 5, a label 518 shows that for year 2013, 50 percent of the time was used for the skill group denoted with color blue. Finally, in FIG. 5, a label 520 shows the overall total use of the different skill groups. From FIG. 5, it may be seen that red is the most used skill group with a total of 29 percent use.

Another objective of the present invention is to use a word cloud to visualize the context or topics covered by the educational or professional experiences. The visualization of the context as a word cloud follows the same principle as the skills above. FIG. 6 illustrates a word cloud 600 of the context on which all the skill groups are applied and each context links to the educational or professional experience where it was last used. In FIG. 6, a label 602 shows the context “Machine Learning” to be very often and recently used. Its superscript with a label 604 indicates that this context was last used in professional experience “10”. Furthermore, since the font type is bold, this context has been learned as part of one of the education programs. In FIG. 6, a label 606 shows a context applied as part of a professional experience and it has a smaller font size since it has not been applied as often or as recently as others. In FIG. 6, a label 608 shows that this context was last applied in professional experience “10”.

Another objective of the present invention is to use a pie and donuts chart to visualize the job titles and industry or sectors that correspond to the professional experiences. Specific objects that may be implemented in such pie and donuts chart may include giving each job title a superscript number that links it to the corresponding experience and providing the whole of the industries or sectors corresponding to the educational or professional experiences. The donut chart provides the whole of the education or job titles in relation to the sector part. The color of each part in the pie chart reveals the top skill group applied in that industry or sector. The color of each part in the donut chart reveals the top skill group applied under that job title.

FIG. 7 illustrates a pie and donuts chart 700 that shows the relationship of educational or professional experience titles as components of the whole candidate's career, according to an exemplary embodiment of the present invention. It also shows the relationship of industry exposure to a whole. It reveals the titles that the candidate held for each educational or professional experience, the amount of time percent-wise holding that title, and links it to the corresponding education or professional experience using the number superscript. The donuts chart part shows the industry or sector and what skill group was the top one used. The titles that correspond to an education experience are shown in bold. In FIG. 7, a label 702 shows the donuts segment as part of the whole as an “Undergraduate Student” and connected to the education identified by “1”. In FIG. 7, a label 704 shows the percent spent by the candidate completing that education relative to her whole career. In FIG. 7, a label 706 shows the student title and the bold font reveals that this title was held while completing an education as opposed to a professional experience in the education sector. In FIG. 7, a label 708 links the title to the corresponding education in the stacked bar chart skills plot identified with “1”. In FIG. 7, a label 710 shows that this donut segment belongs to the industry or sector “Education” and that the main skill group applied as part of this sector was the skill group identified with color green.

Another objective of the present invention is to provide skill group badges that, by convention, allow quickly identifying top skills and enables the resume reader to identify a candidate match instantly. For example, the “diamond” badge for skill X reveals that the candidate has effectively used skill group X for at least five years and the candidate has used skill X at least once within the last three years. It allows the resume reader to instantly recognize the candidate as mastering skill group X. The skill badges are defined as follows. Diamond—the candidate has effectively used skill group X at least five full years and the candidate has used it at least once in the last three years. Star—the candidate has effectively used skill group X at least two full years and the candidate has used it at least once in the last two years. Half-Star—the candidate has effectively used skill group X at least one full year and the candidate has used it at least once in the last year. The skill group badges concept is not limited to these conventions and may be modified or extended to cover slightly similar variations of those conventions.

FIG. 8 illustrates a set of badges 800 that reveal a level of expertise using those skill groups, according to an exemplary embodiment of the present invention. In FIG. 8, a label 802 is a Diamond and shows that the candidate has effectively used skill group identified with color red at least five full years and at least once in the last three years. In FIG. 8, a label 804 is a Star and shows that the candidate has effectively used skill group identified with color blue at least two full years and at least once in the last two years. In FIG. 8, a label 806 is a half-Star and shows that the candidate has effectively used skill group identified with color purple at least one year and at least once within the last year.

FIG. 9 illustrates an exemplary resume 900 as compiled by a data science system such as the application server 102, according to an exemplary embodiment of the present invention. The application server 102 may compile the one or more skill word clouds (such as the skill word cloud 400), one or more bar graphs (such as the stacked bar chart 500), one or more context word clouds (such as the context word cloud 600), one or more pie and donuts charts (such as the pie and donuts chart 700), and one or more skill group badges conventions (such as the set of badges 800) to generate the exemplary resume 900 for the candidate such as the candidate 110.

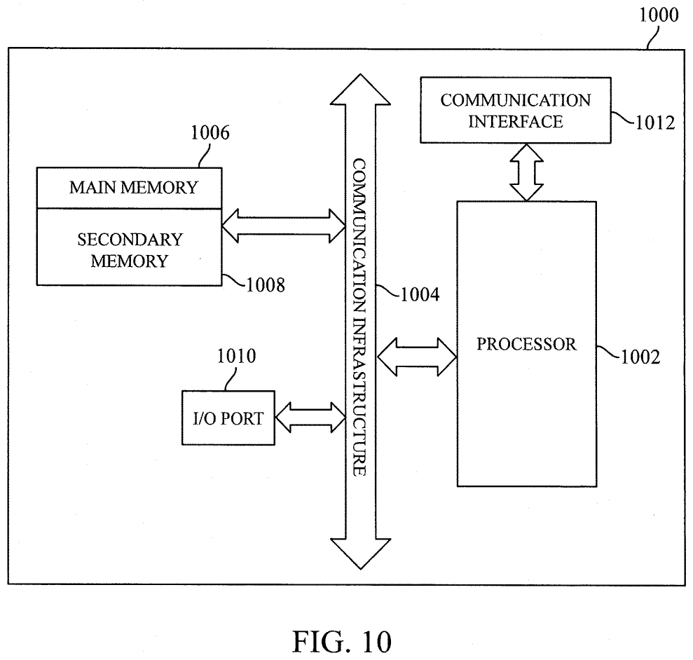

FIG. 10 is a block diagram that illustrates a system architecture of a computer system 1000 for generating the holistic graphical representation of the resume in the vector graphic form (as shown in FIG. 9), according to an exemplary embodiment of the present invention. An embodiment of the present invention, or portions thereof, may be implemented as computer readable code on the computer system 1000. In one example, the application server 102 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the various operations illustrated in the present invention. The computer system 1000 includes a processor 1002 that may be a special purpose or a general-purpose processing device. The processor 1002 may be a single processor, multiple processors, or combinations thereof. The processor 1002 may have one or more processor “cores.” Further, the processor 1002 may be connected to a communication infrastructure 1004, such as a bus, a bridge, a message queue, the network 106, multi-core message-passing scheme, and the like. The computer system 1000 further includes a main memory 1006 and a secondary memory 1008. Examples of the main memory 1006 may include RAM, ROM, and the like. The secondary memory 1008 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system 1000 further includes an input/output (I/O) port 1010 and a communication interface 1012. The I/O port 1010 includes various input and output devices that are configured to communicate with the processor 1002. Examples of the input devices may include a keyboard, a mouse, a joystick, a touchscreen, a microphone, and the like. Examples of the output devices may include a display screen, a speaker, headphones, and the like. The communication interface 1012 may be configured to allow data to be transferred between the computer system 1000 and various devices that are communicatively coupled to the computer system 1000. Examples of the communication interface 1012 may include a modem, a network interface, i.e., an Ethernet card, a communications port, and the like. Data transferred via the communication interface 1012 may be signals, such as electronic, electromagnetic, optical, or other signals as will be apparent to a person skilled in the art. The signals may travel via a communications channel, such as the network 106, which may be configured to transmit the signals to the various devices that are communicatively coupled to the computer system 1000. Examples of the communication channel may include, but not limited to, cable, fiber optics, a phone line, a cellular phone link, a radio frequency link, a wireless link, and the like. Computer program medium and computer usable medium may refer to memories, such as the main memory 1006 and the secondary memory 1008, which may be a semiconductor memory such as dynamic RAMs. The main memory 1006 or the secondary memory 1008 may be used for storing a set of algorithms or instructions comprising at least a word cloud algorithm or instructions, a stacked bar chart algorithm or instructions, a context word cloud algorithm or instructions, a pie and donuts algorithm or instructions, and a badge algorithm or instructions. These computer program mediums may provide data that enables the computer system 1000 to implement the present invention. The processor 1002 may execute the word cloud algorithm or instructions to generate the one or more skill word clouds (such as the skill word cloud 400). The processor 1002 may execute the stacked bar chart algorithm or instructions to generate the one or more bar graphs (such as the stacked bar chart 500). The processor 1002 may execute the context word cloud algorithm or instructions to generate the one or more context word clouds (such as the context word cloud 600). The processor 1002 may execute the pie and donuts algorithm or instructions to generate the one or more pie and donuts charts (such as the pie and donuts chart 700). The processor 1002 may execute the badge algorithm or instructions to generate the one or more skill group badges conventions (such as the set of badges 800). In an embodiment, the present invention is implemented using a computer implemented application. The computer implemented application may be stored in a computer program product and loaded into the computer system 1000 using the removable storage drive or the hard disk drive in the secondary memory 1008, the I/O port 1010, or the communication interface 1012.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

What is claimed is:

1. A system for generating a graphical vector resume, comprising:
an application server comprising:
a memory for storing a set of algorithms or instructions comprising at least a word cloud algorithm or instructions, a stacked bar chart algorithm or instructions, a pie and donuts algorithm or instructions, and a badge algorithm or instructions; and
a processor, wherein said processor is configured to execute said set of algorithms or instructions stored in said memory to:
retrieve a plurality of candidate data of a candidate from a candidate computing device or a database server over a network;
generate at least a skill word cloud, a stacked bar chart, a context word cloud, a pie and donuts chart, and a set of badges based on respective candidate data; and
compile together said generated skill word cloud, said generated stacked bar chart, said generated context word cloud, said generated pie and donuts chart, and said generated set of badges to generate a graphical vector resume for said candidate.

2. The system of claim 1, wherein said plurality of candidate data comprises at least percentage (or similar measures such as probability) of use of one or more skills per year data, education history, work history, work responsibilities, and demographic information.

3. The system of claim 2, wherein said processor is further configured to render a user interface on said candidate computing device,
wherein said user interface comprises a web application; and
wherein said user interface prompts said candidate to enter said plurality of candidate data.

4. The system of claim 1,
wherein said processor executes said word cloud algorithm or instructions to process said plurality of candidate data to generate a word weight and a word color associated with said plurality of candidate data; and
wherein said execution of said word cloud algorithm or instructions outputs said plurality of candidate data modified by said word weight and said word color as a word cloud comprising at least one of said skill word cloud or said context word cloud.

5. The system of claim 4,
wherein said processor executes said stacked bar chart algorithm or instructions to process said plurality of candidate data including a percentage of use of one or more skills per year to generate a plurality of stacked bars associated with said plurality of candidate data; and
wherein said execution of said stacked bar chart algorithm or instructions outputs said plurality of percentage of use of said one or more skills per year as said stacked bar chart.

6. The system of claim 5,
wherein said processor executes said pie and donuts algorithm or instructions to process said plurality of candidate data to generate a plurality of pie and donuts associated with said plurality of candidate data; and
wherein said execution of said pie and donuts algorithm or instructions outputs said plurality of candidate data as said pie and donuts chart.

7. The system of claim 6,
wherein said processor executes said badge algorithm or instructions to process said plurality of candidate data to generate a plurality of badges associated with said plurality of candidate data; and
wherein said execution of said badge algorithm or instructions outputs said plurality of candidate data as a plurality of badges of said set of badges.

8. The system of claim 7,
wherein said processor is further configured to generate said graphical vector resume for said candidate based on said word cloud, said stacked bar chart, said pie and donuts chart, said plurality of badges and a summary.

9. The system of claim 1, wherein said application server further comprises a social network crawler or integration with its public API, and wherein said social network crawler or via its public API access acquires said plurality of candidate data from a social network profile of said candidate.

10. The system of claim 9, wherein said plurality of candidate data acquired from said social network profile of said candidate is compared against a reference database to generate a recommended candidate data set.

11. The system of claim 10, wherein said recommended candidate data set is presented to said candidate on said candidate computing device for review and modification prior to processing by said processor using said set of algorithms or instructions.

12. The system of claim 11,
wherein said graphical vector resume is printable on a single sheet of paper, or
wherein said graphical vector resume is displayable in different output devices.

13. A method for creating a graphical vector resume, comprising:
acquiring, by an application server, a plurality of candidate data of a candidate from a candidate computing device or a database server over a network;
generating, by said application server, a skill word cloud by processing said plurality of candidate data using a word cloud algorithm or instructions;
generating, by said application server, a stacked bar chart plot by processing said plurality of candidate data using a stacked bar chart algorithm or instructions;
generating, by said application server, a context word cloud by processing said plurality of candidate data using said word cloud algorithm or instructions;
generating, by said application server, a pie and donuts chart by processing said plurality of candidate data using a pie and donuts algorithm or instructions;
generating, by said application server, a plurality of summary by processing said plurality of candidate data;
generating, by said application server, a plurality of skill badges by processing said plurality of candidate data using a badge algorithm or instructions; and
laying out said generated skill word cloud, said generated stacked bar chart plot, said generated context word cloud, said generated pie and donuts chart, said generated plurality of summary, and said generated plurality of skill badges as said graphical vector resume.

14. The method of claim 13, wherein said plurality of candidate data comprises at least percentage (or similar measures such as probability) of use of one or more skills per year data, education history, work history, work responsibilities, and demographic information.

15. The method of claim 13,
wherein said acquiring of said plurality of candidate data is done automatically by a social network crawler of said application server or by integration with its public API;
wherein said plurality of candidate data acquired by said social network crawler or by integration with its public API is compared against a reference database to create a recommended candidate data set; and
wherein said recommended candidate data set is presented to said candidate for review and modification prior to processing by said application server using various algorithms.

16. The method of claim 15, wherein said various algorithms comprises a set of algorithms or instructions including at least a word cloud algorithm or instructions, a stacked bar chart algorithm or instructions, a pie and donuts algorithm or instructions, and a badge algorithm or instructions.
